(19) United States
(12) Patent Application Publication
(10) Pub. No.: US 2016/0185034 A1
(43) Pub. Date: Jun. 30, 2016

(54) Dial Production Method and Dial

(71) Applicant: Yazaki Corporation, Tokyo (JP)

(72) Inventor: Masaaki Sano, Shimada-shi (JP)

(73) Assignee: Yazaki Corporation, Tokyo (JP)

(21) Appl. No.: 15/065,943

(22) Filed: Mar. 10, 2016

Related U.S. Application Data
(63) Continuation of application No. PCT/JP2014/073831, filed on Sep. 9, 2014.

(30) Foreign Application Priority Data
Sep. 10, 2013 (JP) 2013-187537

(51) Int. Cl. B29C 59/02

(52) U.S. Cl. CPC B29C 59/026; B29L 2031/7232

(57) ABSTRACT

A dial includes a transparent PC sheet serving as a substrate, a shape transfer resin layer provided on a front surface of the PC sheet and having an irregular shape in a surface of the shape transfer resin layer, and a mirror layer and an ink layer for forming a translucent display portion in at least a part of a back surface of the PC sheet.

### CROSS REFERENCE TO RELATED APPLICATIONS

This application is a continuation of PCT application No. PCT/JP2014/073831, which was filed on Sep. 9, 2014 based on Japanese patent application No. 2013-187537 filed on Sep. 10, 2013, whose contents are incorporated herein by reference. Also, all the references cited herein are incorporated as a whole.

### BACKGROUND OF THE INVENTION

1. Technical Field

The present invention relates to a dial production method and a dial.

2. Background Art

In the background art, there has been known a dial in which a plurality of irregular lines are formed as a decorative pattern by printing or the like on a front surface of an instrument display plate (dial) formed out of synthetic resin. Patterning (mold transferring, printing, hot stamping or laminating) with a spinning pattern, a radial pattern, a hairline pattern, etc. is performed on a PC sheet serving as a base material of the dial, and combined with mirror printing to provide a feeling of metal to the dial.

An instrument dial 501 disclosed in Patent Literature JP-A-2007-33427 includes a substrate 505 where a plurality of irregular lines 503 are formed as a decorative pattern on its front surface as shown in FIGS. 5A and 5B. The irregular lines 503 are formed so that concentric irregular lines 503 adjacent to each other can extend substantially in parallel with each other. Scale portions 507 and character portions are formed on the irregular lines 503 by printing, hot stamping or the like.

The feeling of metal in the front surface of the substrate 505 is converted into a numerical value as a ratio Gp/Gv between glossiness Gp of the substrate 505 in a line direction of the irregular lines 503 and glossiness Gv of the substrate 505 in a direction perpendicular to the line direction. An interval P between adjacent ones of the irregular lines 503 and an irregularity height H of each irregular line 503 from the front surface of the substrate 505 are set so that the ratio Gp/Gv can meet a desired value.

### SUMMARY

A precise mold in which grooves corresponding to the shapes of the irregular lines 503 have been formed is used for resin molding of the substrate 505. Thus, the irregular lines 503 of the aforementioned instrument display plate 501 are formed by mold transferring. That is, thermoplastic resin is used for resin molding of the substrate 505. The irregular lines 503 of the instrument display plate 501 are not limited to the mold transferring. Alternatively, the irregular lines 503 of the instrument display panel 501 may be formed by processing such as printing (screen printing) with a plate capable of printing and forming the irregular lines 503, hot stamping with a transfer film together with a precise mold capable of thermally transferring the irregular lines 503 from the transfer film, or laminating by pasting (thermocompression bonding or the like) a film in which the irregular lines 503 have been formed.

However, according to screen printing in which a fluid (ink) with flowability is applied by printing or mold transferring in which thermoplastic resin is used, there is a limit in obtaining a large irregularity height H at a small interval P. It is therefore difficult to form high-definition irregular lines 503. On the other hand, according to hot stamping using a transfer film and a precise mold capable of thermally transferring the irregular lines 503 from the transfer film or laminating by pasting (thermocompression bonding or the like) a film in which the irregular lines 503 have been formed, there arises a problem that the manufacturing cost is increased due to complicated steps.

The present invention has been developed in consideration of the aforementioned circumstances. An object of the invention is to provide a dial production method and a dial in which a dial showing a high feeling of metal can be manufactured at a low cost.

The aforementioned object according to the invention is attained by the following configurations.

(1) A dial production method including steps of: providing a liquid shape transfer resin layer on a front surface of a light transmissive resin sheet serving as a substrate of a dial; pressing a molding surface, in which an irregular shape has been formed, against the shape transfer resin layer; curing the shape transfer resin layer against which the molding surface has been pressed; separating the resin sheet from the molding surface together with the cured shape transfer resin layer; and providing a light shielding layer so that a translucent display portion is formed in at least a part of a back surface of the resin sheet.

According to the dial production method having the aforementioned configuration (1), a liquid shape transfer resin layer is provided on a front surface of a light transmissive resin sheet, and a molding surface in which an irregular shape has been formed is then pressed against the shape transfer resin layer. On this occasion, the shape transfer resin layer the molding surface is pressed against can be easily deformed following the irregular shape of the molding surface because the shape transfer resin layer is liquid. Therefore, the shape transfer resin layer can be easily filled into an irregularity forming space formed between the shape transfer resin layer and the molding surface. Then, when the shape transfer resin layer is separated from the molding surface together with the resin sheet after the shape transfer resin layer filled into the irregularity forming space is cured, the irregular shape of the molding surface is transferred to and formed in the surface of the cured shape transfer resin layer. That is, even if the irregular shape of the molding surface is a high-definition irregular shape with a small interval and a large irregularity height, the irregular shape can be transferred and formed precisely and easily because the shape transfer resin layer is liquid when the molding surface is pressed against the shape transfer resin layer.

(2) The dial production method according to the aforementioned configuration (1), wherein: the shape transfer resin layer is made of ultraviolet curing resin; and the shape transfer resin layer is cured by ultraviolet rays with which the shape transfer resin layer is irradiated from the back surface side of the resin sheet.

According to the dial having the aforementioned configuration (2), complicated temperature control is not required, but the shape transfer resin layer can be cured easily and uniformly in comparison with the case in which a shape transfer resin layer made of thermoplastic resin or thermosetting resin is heated and cured. As a result, a high-definition dial can be obtained easily with high productivity, and the product cost can be reduced.

(3) A dial including: a light transmissive resin sheet that serves as a substrate of the dial; a shape transfer resin layer that is provided on a front surface of the resin sheet and has an irregular shape in a surface of the shape transfer resin layer; and a light shielding layer that can form a translucent display portion in at least a part of a back surface of the resin sheet.

According to the dial having the aforementioned configuration (3), the irregular shape formed in the surface of the shape transfer resin layer can be formed as a high-definition irregular shape in comparison with mold transferring in which an irregular shape is formed directly in a front surface of a resin sheet, or print forming based on screen printing.

According to a dial production method and a dial according to the invention, a dial showing a high feeling of metal can be provided at a low cost.

The invention has been described briefly. Further, the details of the invention will be made clearer through the following mode for carrying out the invention (hereinafter referred to as “embodiment”) with reference to the accompanying drawings.

### BRIEF DESCRIPTION OF THE DRAWINGS

FIG. 1A is a front view of a dial according to an embodiment of the invention, and FIG. 1B is a sectional view taken on line A-A in FIG. 1A.

FIGS. 2A and 2B are schematic explanatory views for explaining a method for producing the dial shown in FIGS. 1A and 1B.

FIG. 3A is a front view of a dial provided with a spinning pattern, FIG. 3B is a front view of a dial provided with a radial pattern, and FIG. 3C is a front view of a dial provided with hairlines.

FIG. 4 is a schematic configuration view of a grindstone polishing device used in a reference example.

FIG. 5A is a front view of a dial in the background art, and FIG. 5B is a main portion sectional schematic view of FIG. 5A.

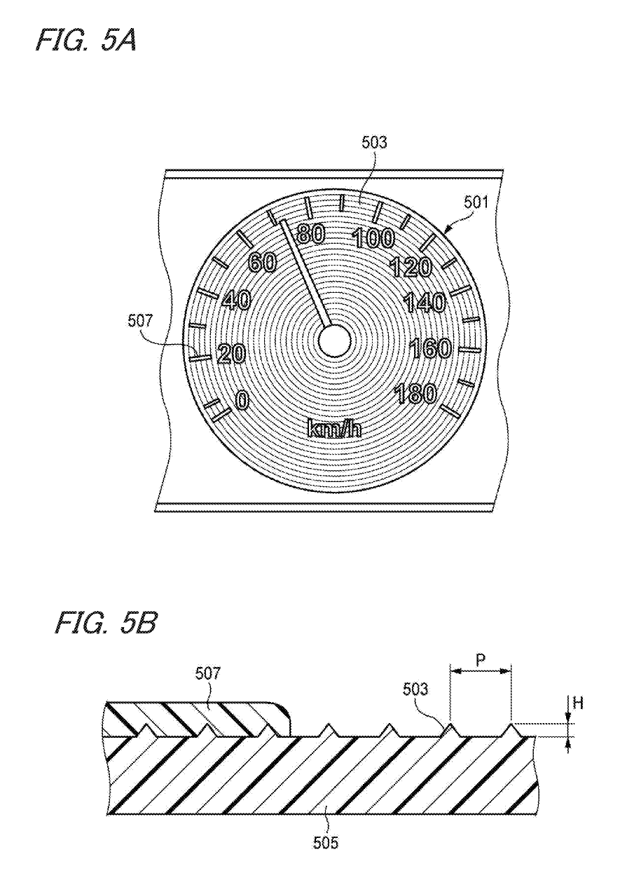

### DETAILED DESCRIPTION OF EMBODIMENTS

An embodiment of the invention will be described below with reference to the drawings.

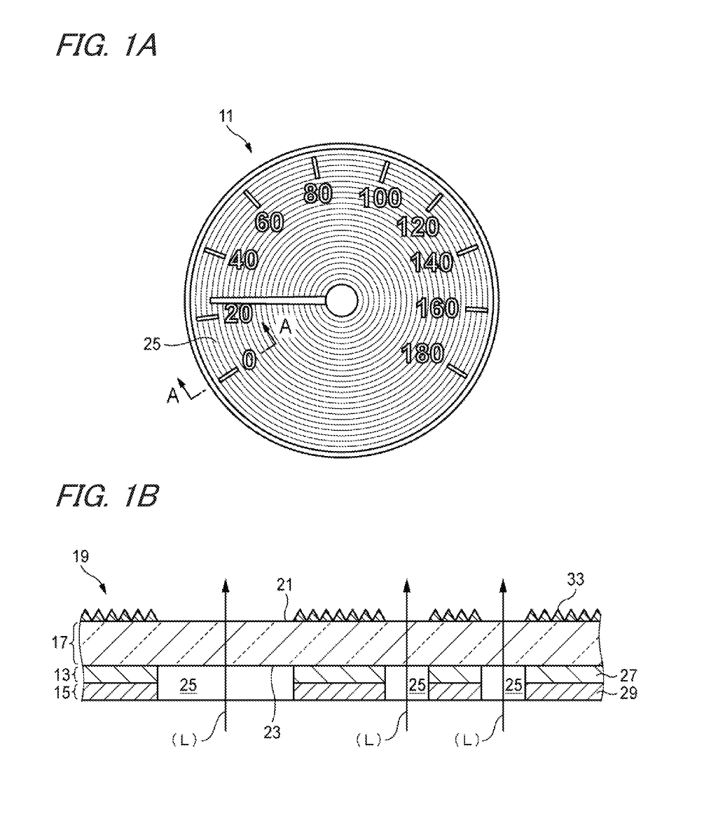

As shown in FIGS. 1A and 1B, a dial 11 according to the embodiment of the invention includes a PC sheet 17, a shape transfer resin layer 19, a mirror layer 13 and an ink layer 15. The PC sheet 17 is a light transmissive resin sheet serving as a substrate of the dial. The shape transfer resin layer 19 is provided on a front surface 21 of the PC sheet 17 and has irregular lines (irregular shape). The mirror layer 13 and the ink layer 15 form a light shielding layer for forming a translucent display portion 25 in a part of a back surface 23 of the PC sheet 17.

A transparent PC sheet (polycarbonate sheet) 17 is used as the resin sheet according to the embodiment. The PC sheet 17 is not limited to a transparent one, but may be a semitransparent one as long as it has enough light transmittance to transmit light (L).

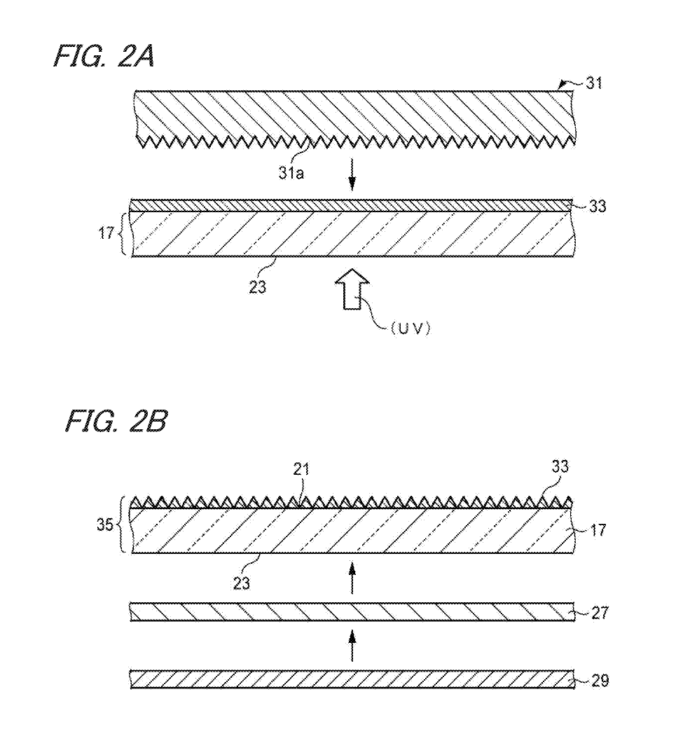

The shape transfer resin layer 19 is formed out of a UV-curing ink 33 that has been cured. Ultraviolet curing resin is, for example, used suitably for the shape transfer resin layer 19. However, thermoplastic resin, thermosetting resin, etc. may be used as long as it can be kept in a liquid state on the front surface 21 of the PC sheet 17 until a molding surface 31a (see FIG. 2A) is pressed against it, and it can be cured in a subsequent step. Incidentally, the liquid shape transfer resin layer 19 is not limited to a flowable one, but may be a jerry-formed one or a gel-formed one as long as it can be easily deformed following the irregular shape of the molding surface 31a.

The mirror layer 13 forming the light shielding layer according to the embodiment is formed out of a mirror ink 27, and the ink layer 15 is formed out of a black ink 29. Incidentally, although the light shielding layer is formed by a lamination of the mirror layer 13 and the ink layer 15 in the embodiment, only one of the mirror layer 13 and the ink layer 15 may be provided. In addition, the mirror layer 13 is not limited to the mirror ink 27, but may be provided by deposition of a metal thin film, or the like. In addition, the ink layer 15 is not limited to the black ink 29, but another color ink may be used. Not to say, the light shielding layer according to the invention is not limited thereto, but various known light shielding materials may be used.

Next, a method for producing the aforementioned dial 11 will be described.

First, as shown in FIG. 2A, the liquid UV-curing ink 33 is provided by spraying or coating on the front surface 21 of the PC sheet 17 serving as a substrate. Next, a mold 31 in which fine irregular lines have been formed in the molding surface 31a by processing is pressed against the UV-curing ink 33 on the PC sheet 17.

Then, the UV-curing ink 33 is irradiated with ultraviolet rays (UV) from the back surface 23 side of the PC sheet 17. Thus, the UV-curing ink 33 is cured.

After the UV-curing ink 33 is cured, the PC sheet 17 is separated from the molding surface 31a of the mold 31 together with the cured UV-curing ink 33. When the PC sheet 17 is separated from the mold 31, an irregular PC sheet 35 in which a pattern of fine irregular lines have been formed in the front surface 21 of the cured UV-curing ink 33 is completed as shown in FIG. 2B.

The mirror ink 27 and the black ink 29 for forming the display portion 25 are printed on the back surface 23 of the irregular PC sheet 35 having the pattern. Thus, the dial 11 shown in FIGS. 1A and 1B is completed.

The mirror ink 27 and the black ink 29 are printed to exclude a dial design. The display portion 25 formed thus constitutes the dial design that can be illuminated by transmitted light.

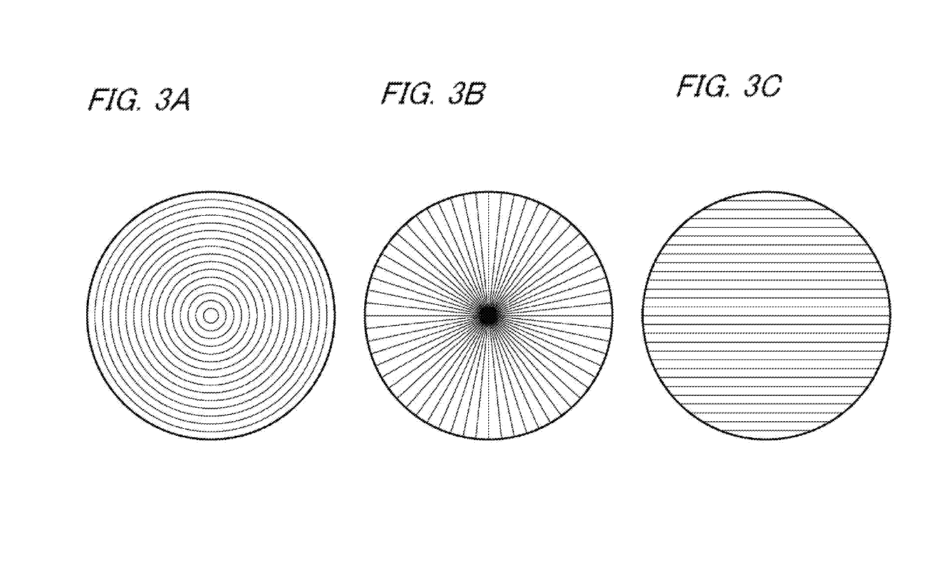

Incidentally, fine irregular lines formed in the molding surface 31a of the mold 31 are transferred to the front surface 21 of the UV-curing ink 33 so as to form a fine irregular line pattern therein. The fine irregular line pattern may be formed as various patterns such as a spinning pattern shown in FIG. 3A, a radial pattern shown in FIG. 3B, a hairline pattern shown in FIG. 3C, etc.

Next, the effect of the aforementioned method for producing the dial 11 will be described.

In the method for producing the dial 11 according to the embodiment, the liquid UV-curing ink 33 is provided on the front surface of the transparent PC sheet 17, and the molding surface 31a of the mold 31 in which a fine irregular shape has been formed is then pressed against the UV-cured ink 33. On this occasion, the UV-curing ink 33 can be easily deformed following the irregular lines of the molding surface 31a because the UV-curing ink 33 the molding surface 31a is pressed against is liquid. Thus, the UV-curing ink 33 can be easily filled into the irregularity forming space formed between the UV-curing ink 33 and the molding surface 31a.

After the UV-curing ink 33 filled into the irregularity forming space is cured, the UV-curing ink 33 is separated from the molding surface 31a together with the PC sheet 17. Thus, the irregular lines of the molding surface 31a are transferred to and formed in the front surface 21 of the cured UV-curing ink 33. That is, even if the irregular lines are high-definition irregular lines with a small interval and a large irregularity height, the irregular lines of the molding surface 31a can be transferred and formed precisely and easily because the UV-curing ink 33 is liquid when the molding surface 31a is pressed against the UV-curing ink 33.

The UV-curing ink 33 relating to the shape transfer resin layer 19 according to the embodiment is made of ultraviolet curing resin, which is irradiated with ultraviolet rays (UV) from the back surface 23 of the PC sheet 17. Thus, the UV-curing ink 33 is cured. In this manner, complicated temperature control is not required, but the UV-curing ink 33 can be cured easily and uniformly in comparison with the case in which a shape transfer resin layer made of thermoplastic resin or thermosetting resin is heated and cured. As a result, a high-definition dial 11 can be obtained easily with high productivity, and the product cost can be reduced.

In addition, the liquid shape transfer resin layer 19 according to the embodiment is formed out of a low-viscosity UV-curing ink 33. Thus, using its own good flowability, the UV-curing ink 33 can be filled into the fine irregularity forming space formed between the UV-curing ink 33 and the molding surface 31a. Thus, the UV-curing ink 33 serves as high-definition irregular lines after the UV-curing ink 33 is cured.

Therefore, according to the dial 11 and the method for producing the dial 11 according to the embodiment, the dial 11 showing a high feeling of metal can be provided at a low cost.

Here, the aforementioned features of the embodiment of the dial production method and the dial according to the invention will be summarized and listed in the following paragraphs respectively.

[1] A method for producing a dial 11 including the steps of: providing a liquid shape transfer resin layer 19 on a front surface 21 of a light transmissive resin sheet (PC sheet) 17 serving as a substrate of the dial 11; pressing a molding surface 31a, in which an irregular shape has been formed, against the shape transfer resin layer 19; curing the shape transfer resin layer 19 against which the molding surface 31a has been pressed; separating the resin sheet (PC sheet) 17 from the molding surface 31a together with the cured shape transfer resin layer 19; and providing a light shielding layer (a mirror layer and an ink layer) 13, 15 so that a translucent display portion 25 is formed in at least a part of a back surface 23 of the resin sheet (PC sheet) 17.
[2] The method for producing the dial 11 according to the aforementioned configuration [1], wherein: the shape transfer resin layer 19 is made of ultraviolet curing resin (UV-curing ink) 33; and the shape transfer resin layer 19 is cured by ultraviolet rays with which the shape transfer resin layer 19 is irradiated from the back surface 23 side of the resin sheet (PC sheet) 17.
[3] A dial 11 including: a light transmissive resin sheet (PC sheet) 17 that serves as a substrate of the dial 11; a shape transfer resin layer 19 that is provided on a front surface 21 of the resin sheet (PC sheet) 17 and has an irregular shape in a surface of the shape transfer resin layer 19; and a light shielding layer (a mirror layer and an ink layer) 13, 15 that can form a translucent display portion 25 in at least a part of a back surface 23 of the resin sheet (PC sheet) 17.

Incidentally, the invention is not limited to the aforementioned embodiment, but suitable deformations, improvements and so on may be made thereon. In addition, materials, shapes, dimensions, numbers, arrangement places, etc. of constituent elements in the aforementioned embodiment are not limited but may be selected desirably if the invention can be attained.

### Reference Example

Next, description will be made about a reference example in which an irregular PC sheet 35 was produced by a production method according to the aforementioned embodiment, and the glossiness thereof was measured.

### [Mold]

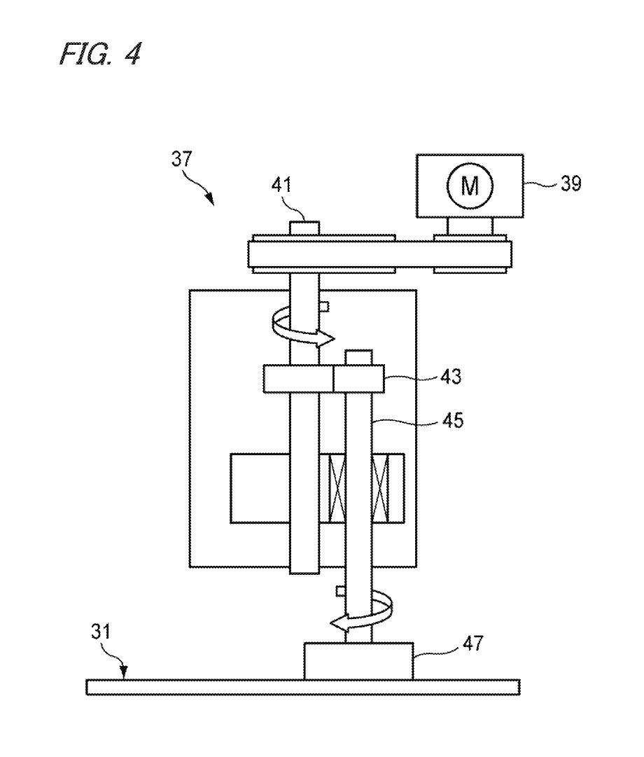

Using a grindstone polishing device 37 shown in FIG. 4A, irregular lines of a spinning pattern were patterned in a molding surface 31a of a mold 31. The grindstone polishing device 37 had a motor 39, a main shaft 41 rotated by the motor 39, a rotating shaft 45 rotating and revolving around the main shaft 41 through a gear 43, and a columnar grindstone 47 fixed to the rotating shaft 45. The grindstone 47 rotates while revolving around the main shaft 41 so that the molding surface 31a of the mold 31 can be patterned.

### [Ink]

An ink having a product name “Ray Cure PF4200 Series” of Jujo Chemical Co., Ltd. and adjusted to be lower in viscosity was used as the UV-curing ink 33.

### [Glossmeter]

The glossiness was measured by a handy glossmeter “GLOSS CHECKER TMS724” made by Sato Shouji Inc.

### [Production Procedure]

The UV-curing ink 33 of a thickness of 8 μm was applied onto the front surface 21 of the PC sheet 17.

The mold 31 with the molding surface 31a in which irregular lines of a spinning pattern had been patterned was pressed onto the front surface 21 of the PC sheet 17 coated with the UV-curing ink 33.

The UV-curing ink 33 was irradiated with ultraviolet rays (UV) from the back surface 23 side of the PC sheet 17. Thus, the UV-curing ink 33 was cured.

The PC sheet 17 was separated from the mold 31. Thus, an irregular PC sheet 35 having a pattern of fine irregular lines in the front surface 21 was obtained.

Table 1 shows a result of measured glossiness of the obtained irregular PC sheet 35.

The glossiness was measured in the state where a black sheet for shielding light was laid under the irregular PC sheet 35, based on “Specular glossiness-Methods of measurement of Japanese Industrial Standards” Z8741. Incidentally, Gp designates glossiness in a direction parallel to the irregular lines, and Gv designates glossiness in a direction perpendicular to the irregular lines.

TABLE 1
Gloss Value (Gossiness)

| | Gv | Gp |
|---|---|---|
| minimum value | 28 | 32 |
| maximum value | 95 | 114 |
| average value | 41.6 | 49.7 |

As is apparent from Table 1, the glossiness of the irregular PC sheet 35 having a spinning pattern in its surface according to the production method of the aforementioned embodiment was 28 to 114.

A dial production method and a dial according to the present invention is useful as a dial production method and a dial in which a dial showing a high feeling of metal can be provided at a low cost.

What is claimed is:

1. A dial production method comprising steps of:
providing a liquid shape transfer resin layer on a front surface of a light transmissive resin sheet serving as a substrate of a dial;
pressing a molding surface; in which an irregular shape has been formed, against the shape transfer resin layer;
curing the shape transfer resin layer against which the molding surface has been pressed;
separating the resin sheet from the molding surface together with the cured shape transfer resin layer; and
providing a light shielding layer so that a translucent display portion is formed in at least a part of a back surface of the resin sheet.

2. The dial production method according to claim 1, wherein:
the shape transfer resin layer is made of ultraviolet curing resin; and
the shape transfer resin layer is cured by ultraviolet rays with which the shape transfer resin layer is irradiated from the back surface side of the resin sheet.
